(19) United States
(12) Patent Application Publication
(10) Pub. No.: US 2026/0042296 A1
(43) Pub. Date: Feb. 12, 2026

(54) PRINTING APPARATUS

(71) Applicant: CANON KABUSHIKI KAISHA, Tokyo (JP)

(72) Inventors: KENTARO MURO, Tokyo (JP); SATOSHI AZUMA, Tokyo (JP); YOSHIAKI MURAYAMA, Tokyo (JP); JUN YASUTANI, Kanagawa (JP); TAKUTO MORIGUCHI, Kanagawa (JP); OSAMU YOSHITAKE, Chiba (JP); RAN KUDO, Tokyo (JP)

(21) Appl. No.: 19/294,819

(22) Filed: Aug. 8, 2025

(30) Foreign Application Priority Data
Aug. 9, 2024 (JP) 2024-134476

(51) Int. Cl. B41J 2/165; B41J 2/18; B41J 2/195

(52) U.S. Cl. CPC B41J 2/16579; B41J 2/1652; B41J 2/16585; B41J 2/18; B41J 2/195

(57) ABSTRACT

A printing apparatus includes a moving unit configured to relatively move a print medium and a discharging unit including an orifice configured to discharge a liquid to the print medium, a blowing unit configured to blow air to the orifice, and a detection unit configured to detect a humidity of the air.

### BACKGROUND

### Field of the Technology

The present disclosure relates to a printing apparatus.

### Description of the Related Art

If a discharge head for discharging a liquid such as ink is kept in a state without liquid discharge for a long time, a volatile component in the liquid evaporates from orifices, the liquid is condensed, and the concentration of a solid component such as a pigment becomes high. If the concentration of the liquid becomes high, a discharge failure may occur. There is known a technique of removing the liquid from the discharge head if it is estimated that the concentration is high (for example, Japanese Patent Laid-Open No. 2018-8513).

The humidity near the orifices affects evaporation of the volatile component in the liquid. In some cases, the accuracy of estimating the concentration of a solid component in the liquid can be improved by detecting the humidity in the printing apparatus. However, if the liquid is discharged by a printing operation, a humidity distribution is generated in the printing apparatus due to the influence of water of the discharge liquid. A difference may be generated between the detection result of the humidity sensor and the humidity near the orifices.

### SUMMARY

The present disclosure provides a technique of improving the accuracy of detecting a humidity near an orifice.

According to one aspect of the present disclosure, there is provided a printing apparatus comprising: a moving unit configured to relatively move a print medium and a discharging unit including an orifice configured to discharge a liquid to the print medium; a blowing unit configured to blow air to the orifice; and a detection unit configured to detect a humidity of the air.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic view of a printing apparatus according to the embodiment of the present disclosure;

FIG. 2 is a plan view of the conveyance unit of the printing apparatus shown in FIG. 1;

FIG. 3A is an explanatory view showing the configuration of a discharge head;

FIG. 3B is an explanatory view showing the configuration of a heater board;

FIG. 4A is a sectional view of the discharge head;

FIG. 4B is an explanatory view of a circulation unit;

FIG. 5 is a view showing the position of the discharge head during a printing operation;

FIG. 6 is an explanatory view of capping of the discharge head

FIG. 7 is a block diagram of the control unit of the printing apparatus shown in FIG. 1;

FIG. 8 is a flowchart showing an example of processing executed by the control unit;

FIG. 9A is a flowchart showing an example of processing executed by the control unit;

FIG. 9B is a view showing an example of an evaporation speed setting table;

FIG. 10 is a flowchart showing an example of processing executed by the control unit;

FIGS. 11A to 11C are views showing an example of data used for processing;

FIG. 12 is a view showing another example of the arrangement of blowing units;

FIG. 13 is a view showing another example of the arrangement of a humidity sensor;

FIG. 14 is a view showing another example of the arrangement of blowing units and a humidity sensor;

FIG. 15A is a view showing another example of the configuration of the conveyance unit;

FIG. 15B is a view showing an example of application to a serial type printing apparatus; and

FIG. 16 is a view showing another example of an ink removing portion.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

### <Configuration of Printing Apparatus>

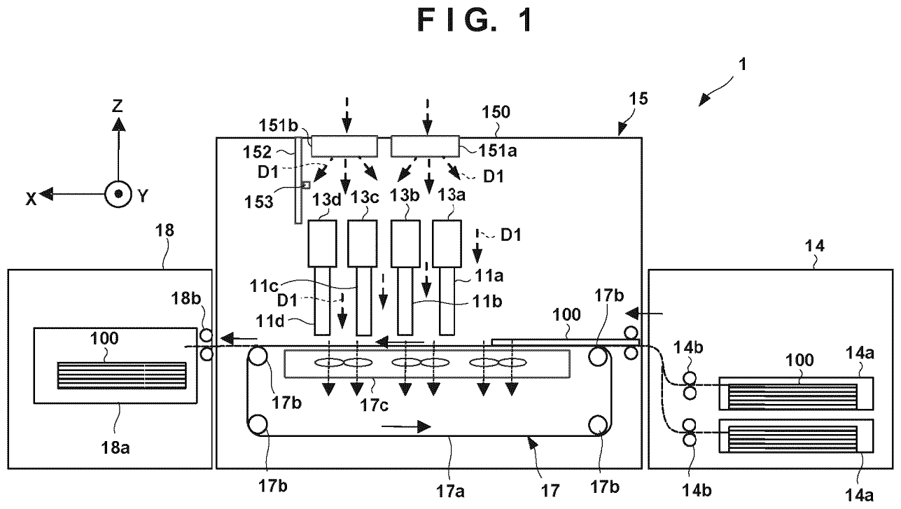

FIG. 1 is a schematic view of a printing apparatus 1 according to the embodiment of the present disclosure. The printing apparatus 1 is an apparatus that discharges liquid ink to a print medium 100 and prints an image. In the drawings, arrows X, Y, and Z indicate directions crossing each other, and the X and Y directions are horizontal directions orthogonal to each other. The Z direction is the up/down direction. In this embodiment, the X direction, the Y direction, and the Z direction indicate the whole length direction, the depth direction, and the height direction of the printing apparatus 1, respectively.

Note that “print” includes not only forming significant information such as characters and graphics but also forming images, figures, patterns, and the like on print media in a broad sense, or processing media, regardless of whether the information is significant or insignificant or whether the information is visualized so that a human can visually perceive it. In addition, although in this embodiment, sheet-like paper is assumed as a “print medium”, cloth, a plastic film, and the like may also be used.

The printing apparatus 1 includes a feeding device 14, an image forming device 15, and a collection device 18. The feeding device 14 is a device that feeds the print medium 100 to the image forming device 15. The feeding device 14 includes a stacking unit 14a on which a plurality of print media 100 before printing are stacked, and a conveyance mechanism 14b. In this embodiment, a plurality of stacking units 14a are provided, and the conveyance mechanism 14b is provided in correspondence with each stacking unit 14a. The conveyance mechanism 14b includes a roller pair that clamps and conveys the print medium 100.

The collection device 18 is a device that collects the printed print medium 100 delivered from the image forming device 15. The collection device 18 includes a stacking unit 18a on which a plurality of print media 100 that are printed products are stacked, and a conveyance mechanism 18b. The conveyance mechanism 18b includes a roller pair that clamps and conveys the print medium 100.

The image forming device 15 includes a conveyance unit 17 that conveys the print medium 100 in the X direction, a plurality of discharge heads 11a to 11d that discharge a liquid to the print medium 100, and lifting units 13a to 13d that move up/down the discharge heads 11a to 11d. If the discharge heads 11a to 11d are generally expressed, or the individual discharge heads 11a to 11d are not discriminated, these will simply be referred to as a discharge head 11. Similarly, if the lifting units 13a to 13d are generally expressed, or the individual lifting units 13a to 13d are not discriminated, these will simply be referred to as a lifting unit 13.

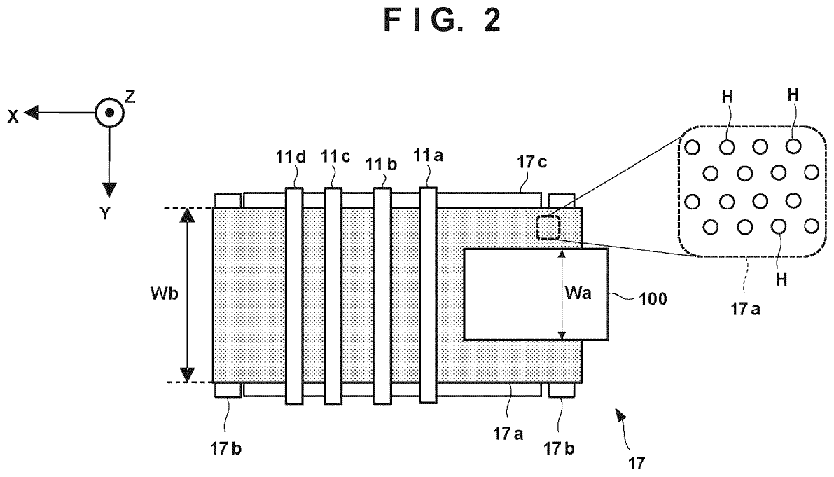

In addition to FIG. 1, FIG. 2 will also be referred to. FIG. 2 is a plan view of the conveyance unit 17. The conveyance unit 17 is an example of a moving mechanism that relatively moves the discharge heads 11 and the print medium 100. Here, these are relatively moved by moving the print medium 100 with respect to the discharge heads 11 at rest. The conveyance unit 17 includes an endless conveyance belt 17a, a plurality of rollers 17b that cause the conveyance unit 17a to travel, and a suction device 17c. The plurality of rollers 17b are each rotated about a shaft in the Y direction by a driving source (for example, a motor) (not shown). The conveyance belt 17a circulatingly travels counterclockwise in FIG. 1 along with the rotation of the plurality of rollers 17b.

As the material of the conveyance belt 17a, a resin or a metal can be used. The conveyance belt 17a is a conveyance medium for the print medium 100, which travels in the X direction while having the print medium 100 placed thereon in a part of its traveling section (called a conveyance section or a printing section). In the conveyance section, the conveyance belt 17a faces the lower surface (an orifice surface 110 to be described later) of the discharge head 11.

A number of holes H are formed in the conveyance belt 17a at a predetermined pitch. The suction device 17c includes, for example, an electric fan. In the conveyance section, the suction device 17c is located under the conveyance belt 17a and generates an airflow from above to the downstream side in the Z direction. By the action of the suction device 17c, air is sucked from the many holes H of the conveyance belt 17a in the conveyance section. Thus, in the conveyance section, the print medium 100 is conveyed while being attracted to the conveyance belt 17a, and the conveyance behavior of the print medium 100 can be stabilized. The air pressure of suction can be, for example, −500 Pa. The conveyance speed cab be, for example, 0.5 m/s.

Note that in this embodiment, the conveyance form of the print medium 100 is attraction conveyance using suction of air. However, it may be attraction conveyance using attraction of static electricity. In addition, a unit having a function of drying or cooling the print medium 100 may be added to the conveyance unit 17.

The discharge head 11 is a printhead that prints an image by discharging a liquid to the print medium 100. The discharge head 11 is a full line type head extended in the widthwise direction (Y direction) of the print medium 100, and orifices for the liquid are arrayed in a range covering the width of the print medium 100 with the maximum usable size. FIG. 2 shows a width Wa of the print medium 100 of an intermediate size as an example. The effective length (for example, 368 mm) of the orifice array of the discharge head 11 falls within a width Wb (for example, 380 mm) of the conveyance belt 17a.

The discharge heads 11a to 11d are disposed side by side from the upstream side to the downstream side in the conveyance direction of the print medium 100. The discharge heads 11a to 11d discharge different types of inks. For example, the discharge heads 11a to 11d sequentially discharge four types of inks, that is, yellow ink, magenta ink, cyan ink, and black ink. The four types of inks are sometimes called basic color inks. Note that the types and number of inks and the discharge order in the conveyance direction of the print medium 100 (the arrangement order of the discharge heads 11a to 11d) are not limited to these.

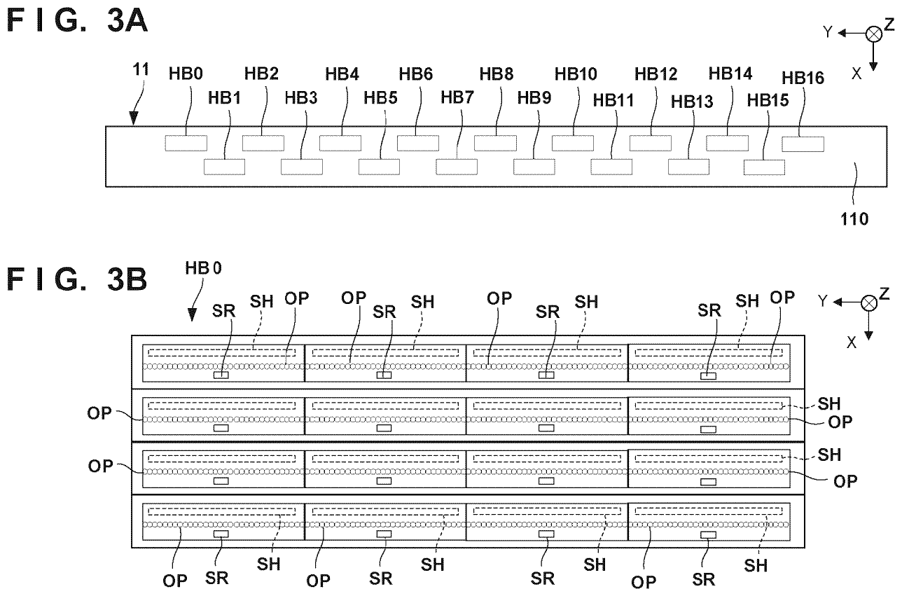

The configuration of the discharge head 11 will be described with reference to FIGS. 3A and 3B. FIG. 3A is an explanatory view showing the configuration of the discharge head 11, and FIG. 3B is an explanatory view of a heater board. As shown in FIG. 3A, as an example, 17 heater boards (printing element substrates) HB0 to HB16 are provided in each discharge head 11. FIG. 3B shows an example of the configuration of the heater board HB0, and the remaining heater boards HB1 to HB16 have the same configuration.

In the heater board HB0, an orifice array having a plurality of orifices OP arranged in the Y direction is formed. A plurality of orifice arrays (four arrays in the example shown in FIG. 3B) are formed apart in the X direction. The heater board HB0 is provided with temperature sensors SR and sub heaters SH that are heating elements. If a voltage is applied to the sub heater SH, the sub heater SH generates heat to heat the substrate of the heater board HB0, and ink near the substrate is heated by the warmed substrate. It is possible to efficiently discharge ink at the time of ink discharge by adjusting the temperature of the ink using the sub heater SH in advance. The heater board HB0 is divided into 4×4=16 sections, and one sub heater SH is provided in each section. The heater board HB0 can thus be heated on a section basis.

The temperature sensor SR is a sensor configured to detect the temperature of the heater board HB0. In this embodiment, application of a driving pulse to the sub heater SH is controlled based on the temperature detected by the temperature sensor SR during and before printing, thereby setting the temperature of ink to a desired temperature.

As shown in FIG. 3A, in the heater boards HB0 to HB16, adjacent heater boards are arranged in zigzag such that the end portions of each other's orifice arrays overlap in the X direction. The lower surface of each discharge head 11 forms the orifice surface 110 in which the orifice arrays are formed. Note that the discharge head 11 may be configured not by the plurality of heater boards HB0 to HB16 but by one heater board having an orifice array long in the Y direction.

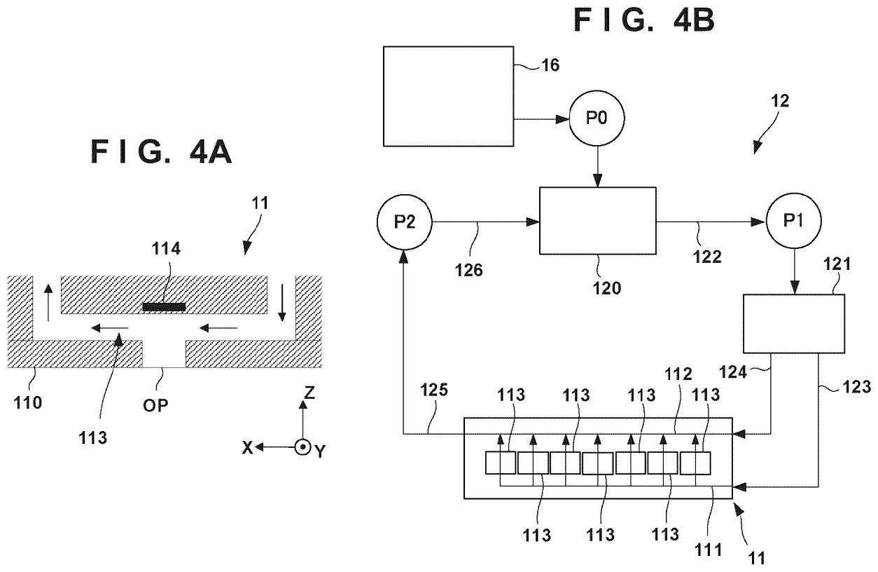

FIG. 4A is an X-Z sectional view of the periphery of one orifice OP. The orifice OP communicates with an individual channel 113 for each orifice OP, and a printing element 114 for each orifice OP is provided in the individual channel 113. The printing element 114 is, for example, an electrothermal transducer and generates heat energy when a driving pulse is applied. Ink is foamed by the generated heat energy and discharged from the corresponding orifice OP. Note that as the printing element 114, a piezoelectric element, an electrostatic element, or a MEMS element can be used in addition to the electrothermal transducer.

In the individual channel 113, the ink flows in a direction indicated by arrows in FIG. 4A. In this embodiment, the ink is circulatingly supplied to the discharge head 11. FIG. 4B is an explanatory view of a circulation unit 12 that circulates the ink.

The printing apparatus 1 includes a main tank 16, a sub tank 120, and the circulation unit 12 for each discharge head 11. The main tank 16 and the sub tank 120 are liquid containers each configured to store ink to be discharged from the corresponding discharge head 11. For example, the main tank 16 and the sub tank 120 corresponding to the discharge head 11a store orange ink. When a pump P0 is driven, the ink is supplied from the main tank 16 to the sub tank 120. If a predetermined amount of ink is supplied from the main tank 16 to the sub tank 120, ink supply is stopped. If the remaining ink amount in the sub tank 120 decreases, the ink is supplied again.

The circulation unit 12 includes pumps P1 and P2 and a pressure adjuster 121. The pump P1 pressure-feeds the ink from the sub tank 120 to the pressure adjuster 121 via a pipe 122. The pressure adjuster 121 gives a pressure difference to the supplied ink and sends it to the discharge head 11. The ink on the relatively high pressure side is sent via a pipe 123, and the ink on the low pressure side is sent via a pipe 124.

The discharge head 11 includes common channels 111 and 112. The common channel 111 is connected to the pipe 123, and the ink on the high pressure side is supplied to the common channel 111. One end of the common channel 112 is connected to the pipe 124, and the ink on the low pressure side is supplied to the common channel 112. The individual channels 113 are connected between the common channel 111 and the common channel 112. The ink flows from the common channel 111 to the common channel 112 via the individual channels 113.

The other end of the common channel 112 is connected to a pipe 125. The pump P2 pressure-feeds the ink from the common channel 112 to the sub tank 120 via the pipes 125 and 126. The ink is thus circulated between the sub tank 120 and the discharge head 11.

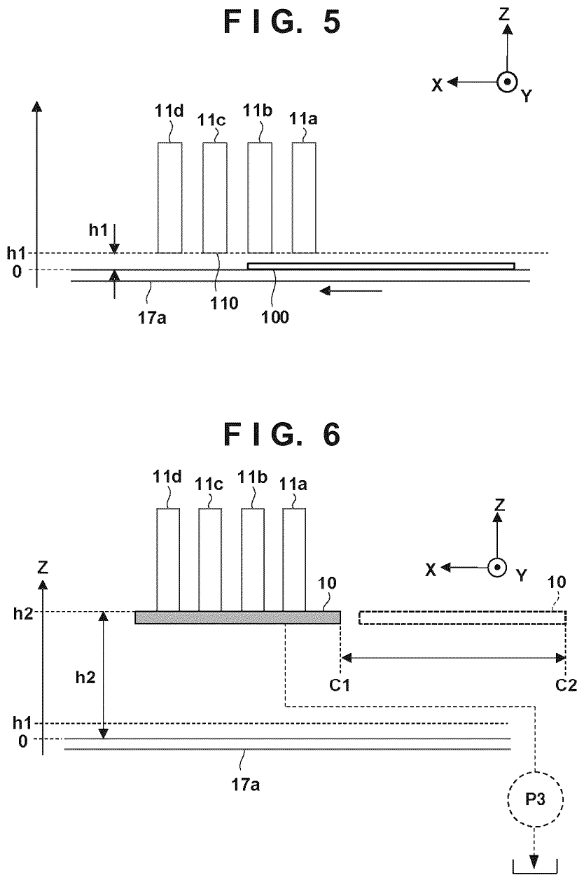

The lifting unit 13 will be described with reference to FIGS. 1 and 5. FIG. 5 is a view showing an example of the height of the discharge heads 11 during a printing operation.

The lifting unit 13 is a mechanism that changes the height from the surface of the print medium 100 to the orifice surface 110 of the discharge head 11 in the conveyance section of the conveyance belt 17a. In this embodiment, the height from the surface of the print medium 100 to the orifice surface 110 of the discharge head 11 is changed by moving the discharge head 11 up/down. The height may be changed by moving the conveyance unit 17 up/down.

The lifting unit 13 is provided for each discharge head 11, and can change the Z-direction position of the discharge head 11 for each discharge head. For example, the lifting unit 13a moves the discharge head 11a up/down, thereby changing its Z-direction position. Note that in this embodiment, the discharge heads 11 can individually be moved up/down. The plurality of discharge heads 11 may be moved up/down by one lifting unit 13. In this case, the Z-direction positions of the plurality of discharge heads 11 moved up/down by one lifting unit 13 are commonly changed. The lifting unit 13 includes, for example, a driving source such as a motor and an actuation mechanism that moves the discharge head 11 by the driving force of the driving source. The actuation mechanism is, for example, a ball screw mechanism, a belt transmission mechanism, a link mechanism, or the like.

In the printing operation, each discharge head 11 is arranged at a position where the height of the orifice surface 110 with respect to the surface of the print medium 100 is a height h1 (called a printing position). The height h1 is a very small gap (for example, about several mm).

During wait for execution of a print job, the discharge heads 11 may be moved to a retreat position and capped. FIG. 6 shows an example. The orifice surfaces 110 of the discharge heads 11 are capped by a cap member 10. During capping, the discharge heads 11 are moved to the retreat position by the lifting units 13. The retreat position is a position where the height of the orifice surface 110 with respect to the surface of the print medium 100 is a height h2 higher than the height h1.

The cap member 10 is moved between a capping position C1 at which the orifice surface 110 is covered and a retreat position C2 where the orifice surface 110 is not covered, as shown in FIG. 6, by a moving mechanism (not shown). By the capping, evaporation of the liquid component of the ink from the orifices OP is suppressed during wait for execution (during standby in a non-printing state). If a print instruction is received, the cap member 10 moves from the capping position C1 to the retreat position C2, and the capping state is canceled. Then, the lifting unit 13 is driven, thereby lowering the discharge heads 11 to the printing position. Conveyance of the print medium 100 by the conveyance unit 17 is thus started. A timing at which the print medium 100 passes under the discharge heads 11 and an ink discharge timing are synchronized, and an image is printed on the print medium 100. When printing of the image is ended, the discharge heads 11 are raised to the retreat position again, and capping is performed.

The discharge heads 11 are moved to the retreat position, and a discharge performance recovery operation may be performed together with capping. As an example, a suction recovery operation of sucking ink for the orifices OP of the discharge heads 11 may be performed. As an example, FIG. 6 shows an example in which the ink is sucked, by a pump P3, from the orifices OP of the discharge heads 11 via the cap member 10 and a pipe and removed to a waste liquid tank. Note that as the discharge performance recovery operation, a preliminary discharge operation can also be performed in addition to the suction recovery operation. In the preliminary discharge operation, the ink is discharged from the orifices OP of the discharge heads 11. The discharge destination is, for example, the cap member 10.

### <Blowing Units and Humidity Sensor>

FIG. 1 will be referred to. The top portion of the housing 150 that forms the outer wall of the image forming device 15 is provided with blowing units 151a and 151b. The blowing units 151a and 151b are electric fans arranged at positions higher than the discharge heads 11 and configured to blow air outside the image forming device 15 to the discharge heads 11. The blowing units 151a and 151b have wind power with which air is blown to the orifices OP of the orifice surfaces 110. Arrows D1 indicate the paths and directions of airflows generated by the blowing units 151a and 151b. The airflow is blown to the upper portions of the discharge heads 11, flows to the lower side between the adjacent discharge heads 11, and reaches the orifice surfaces 110. When the air is blown to the orifices OP, the humidity of the air near the orifices OP can be stabilized.

The blowing units 151a and 151b may have an output that generates an airflow stronger than that generated by the conveyance belt 17a of the conveyance unit 17 or conveyance of the print medium 100. For example, the flow velocity of the airflow blown by the blowing units 151a and 151b may be higher than the relative moving speed between the print medium 100 and the discharge heads 11. In this embodiment, the relative moving speed is the conveyance speed of the print medium 100. Hence, the flow velocity of the airflow blown by the blowing units 151a and 151b may be higher than the conveyance speed of the print medium 100. Thus, the blowing units 151a and 151b can more reliably blow air to the orifices OP of the orifice surfaces 110.

If the blowing units 151a and 151b blow air to the whole range of the Y-direction width and the X-direction width of the orifice surfaces 110 of the discharge heads 11, the humidity near all the orifices OP can be stabilized. For this reason, not the two blowing units 151a and 151b but three or more blowing units may be arranged as needed. In this case, for example, axial flow type square fans may be arranged in a matrix in the X direction and the Y direction. For example, 2 (columns) in X direction×4 (rows) in Y direction=8 square fans may be arranged in total.

In the housing 150, a humidity sensor 153 is provided. The humidity sensor 153 is supported by a support plate 152. The support plate 152 is fixed to the top portion of the housing 150 and extended to the lower side. The humidity sensor 153 measures the humidity of air blown from the blowing units 151a and 151b (particularly, the blowing unit 151b). In this embodiment, one humidity sensor 153 is provided. However, a plurality of humidity sensors 153 may be installed at an interval in the Y direction. In this case, the humidity may be the average value of the detection results of the plurality of humidity sensors 153.

The humidity sensor 153 according to this embodiment aims at measuring the humidity of air near the orifices OP such that it is used as a parameter of ink concentration estimation, as will be described later. However, the humidity sensor 153 is installed at a position apart from the vicinity of the orifices OP and measures the humidity of air of the blowing units 151a and 151b. The reason will be described.

As for the position to install the humidity sensor 153, a position on the conveyance path of the print medium 100 can also be considered as a candidate. If the humidity sensor 153 is installed on the conveyance path of the print medium 100, a distance needs to be ensured in the height direction such that the print medium 100 does not come into contact with the humidity sensor 153. Then, air of high humidity generated by ink discharge from the discharge heads 11 during the printing operation reaches the position of the humidity sensor 153 arranged on the conveyance path due to convection/diffusion. On the other hand, since the print medium 100 conveyed simultaneously has a low humidity as compared to the high humidity, the humidity of air flowing to the vicinity of the orifices OP of the discharge heads 11 may be lower than the humidity detected by the humidity sensor 153. For this reason, during the printing operation, the correlation between the detection result of the humidity sensor 153 and the actual humidity near the orifices OP is lost, and it may be impossible to properly perform concentration estimation to be described later.

It can also be considered that the humidity sensor 153 is installed on the discharge head 11 itself. However, if the humidity sensor 153 is installed on the discharge head 11 without providing a mechanism, like the blowing units 151a and 151b, for controlling the airflow near the orifices OP, a failure may occur in the humidity sensor. More specifically, fine ink mist generated by the printing operation swirls up due to convection and adheres to the humidity sensor 153. As a result, the humidity sensor 153 may fail (the measured value may be offset). Also, in this embodiment, the discharge head 11 is moved up/down by the lifting unit 13. Installation of the humidity sensor 153 on the discharge head 11 is disadvantageous for wiring of a sensor cable.

If the humidity sensor 153 is simply installed at a position apart from the orifices OP to relax the influence of the ink mist, the same effect as in a case where the humidity sensor 153 is installed on the conveyance path of the print medium 100 may be obtained. That is, the humidity of air flowing to the vicinity of the orifices OP of the discharge heads 11 is may be lower than the detection result of the humidity sensor 153, and the correlation between these may be lost.

Due to the above-described reason, in this embodiment, the humidity sensor 153 is arranged at a position apart from the vicinity of the orifices OP of the discharge heads 11 and detects the humidity of air blown to the orifices OP. Particularly, in the configuration example shown in FIG. 1, the humidity sensor 153 is arranged on the downstream side of the blowing units 151a and 151b in the flowing direction of the airflow generated by the blowing units 151a and 151b and on the upstream side of the discharge heads 11.

### <Control Unit>

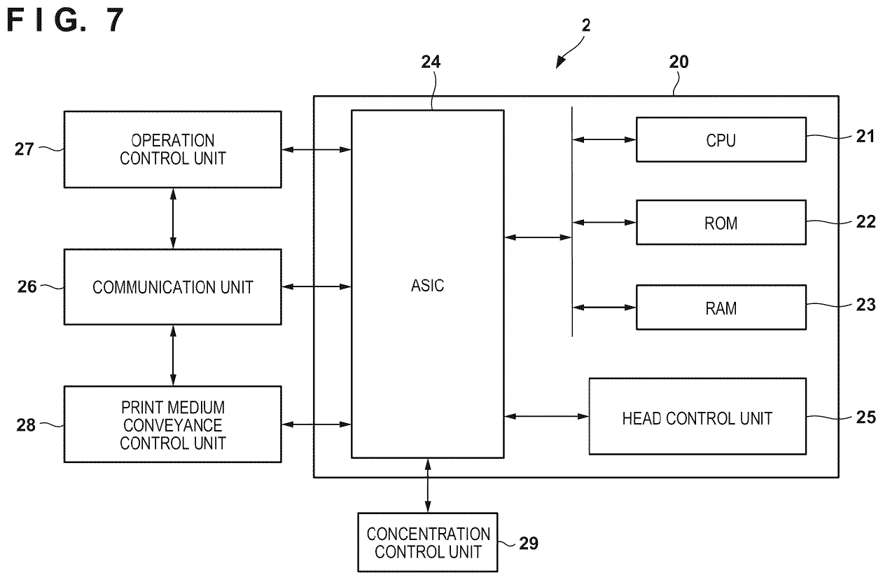

FIG. 7 is a block diagram of a control unit 2 of the printing apparatus 1. The control unit 2 includes a printer control unit 20 that controls a printing process. The printer control unit 20 includes a CPU 21 that controls the overall printing apparatus 1, and a ROM 22 and a RAM 23, which are configured to store control programs to be executed by the CPU 21 and various kinds of data. An integrated circuit (Application Specific Integrated Circuit (ASIC)) 24 incorporates a network controller, a serial IF controller, a head data generation controller, a motor controller, and the like. A head control unit 25 generates final discharge data to be discharged from the discharge heads 11 and driving voltages and controls lifting of the discharge heads 11.

The control unit 2 also includes a communication unit 26 that receives a print job including print data from an external print server or an external PC, an operation control unit 27 that controls an operation panel configured to accept a user input, and a print medium conveyance control unit 28 that controls conveyance of the print medium 100. The control unit 2 also includes a concentration control unit 29 that controls an adjusting operation of adjusting the concentration of a solid component in ink circulated by the circulation unit 12. Each control unit includes at least one processor, and at least one storage device that stores a program to be executed by the processor. The storage device is, for example, a semiconductor memory.

### <Circulation Ink Concentration Adjustment>

In the ink in the discharge head 11, the volatile component in the ink evaporates from the orifices OP, and the concentration of a solid component in the ink becomes high. The solid component is, for example, a coloring material (pigment) or a resin. The rise of the concentration of the solid component causes a discharge failure. Hence, an adjusting operation of adjusting the concentration of the circulation ink is perform for each ink type. The adjusting operation according to this embodiment is an operation of removing the ink in the discharge head 11. The concentration of the solid component in the circulation ink has a deviation, and the concentration is often high for the ink in the discharge head 11. When the ink in the discharge head 11 is removed, the concentration of the solid component in the circulation ink can be made low. The operation of removing the ink in the discharge head 11 may be an operation of discharging the ink from the discharge head 11 or an operation of sucking the ink via the cap member 10 by the pump P3, as exemplified in FIG. 6. The adjusting operation may include an operation of replenishing the ink from the main tank 16 to the sub tank 120 by driving the pump P0, in addition to the operation of removing the ink in the discharge head 11. The circulation ink in which the concentration of the solid component is high can be diluted by the fresh ink in the main tank 16.

If the ink in the discharge head 11 is removed by the adjusting operation, the waste amount of ink increases. It is preferable to suppress wasteful ink consumption as much as possible. To do this, the solid component concentration estimation accuracy needs to be improved. An example of processing of the control unit 2 associated with the solid component concentration adjusting operation will be described. In this embodiment, the concentration of the solid component is estimated, and the adjusting operation is performed based on the estimation result. These processes can be performed at predetermined timings based on the elapse of time, the execution amount of the print job, and the ink discharge amount. In the following example, these processes are performed after the end of the printing operation for every print job execution.

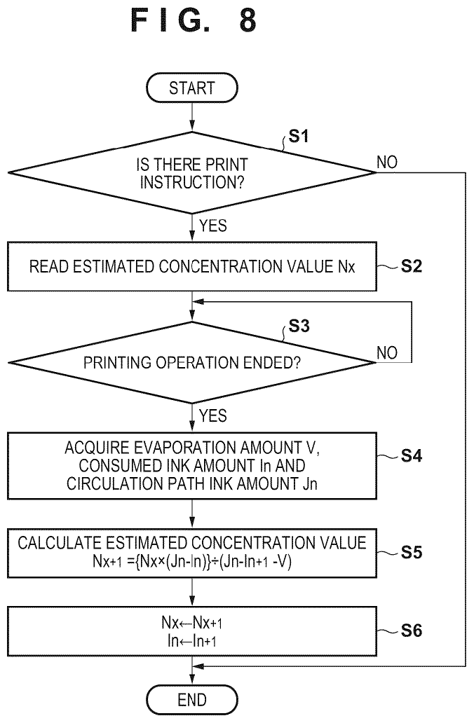

FIG. 8 is a flowchart showing an example of solid component concentration estimation processing that is executed by the concentration control unit 29. Estimation of the concentration of the solid component is performed for each ink type (that is, for each discharge head 11), and the solid component is assumed to be a pigment here.

In step S1, it is determined whether there is a print job execution instruction (print instruction). If there is no print instruction, the processing is ended. If there is a print instruction, the process advances to step S2. In step S2, a current estimated concentration value (preceding estimation result value) Ny is read. The estimated concentration value Ny is stored in, for example, the storage device of the concentration control unit 29 and updated based on the estimation result of the processing shown in FIG. 8. Note that FIG. 11A shows a setting example of an initial value N_{ref} of the estimated concentration value Nₓ. The initial value N_{ref} is the concentration of the pigment in fresh ink and is stored in, for example, the storage device of the concentration control unit 29.

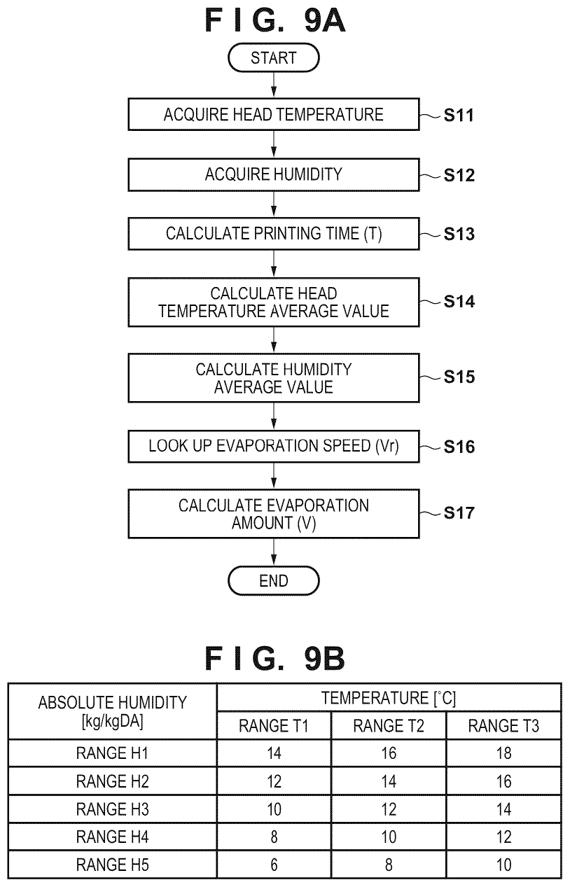

In step S3, it is determined whether the printing operation is ended. Upon determining that the printing operation is ended, the process advances to step S4. In step S4, an evaporation amount V, a consumed ink amount (cumulative value) Iₙ, and a circulation ink amount Jₙ are acquired. The evaporation amount V will be described later with reference to FIG. 9A. The circulation ink amount Jₙ is the initial value of the ink amount in the circulation path, and is preset based on the specifications of the circulation path. FIG. 11B shows an example.

The consumed ink amount Iₙ is the cumulative value of the amounts of ink discharged by the past printing operations and mainly depends on the printing operation contents of print jobs. The amount of ink discharged by the printing operation is calculated from, for example, the count value of the number of pixels of a printed image corresponding to the type of ink. For example, the ink amount can be obtained by multiplying the count value by the discharge amount (for example, 2.0 [ng]) of one discharge. By adding a consumed ink amount Ic in the current printing operation, Iₙ₊₁ is calculated by Iₙ₊₁=Iₙ+Ic.

In step S5, a current estimated concentration value Nₓ₊₁ is calculated based on the values acquired in step S4. This value is calculated by

$${N}_{x + 1} = \{ {N}_{x} \times ( {J}_{n} - {I}_{n} ) \} / ( {J}_{n} - {I}_{n + 1} - V )$$

In step S6, the estimated concentration value Nₓ and the consumed ink amount Iₙ are updated to by the values Nₓ₊₁ and Iₙ₊₁. The processing is thus ended. The estimated concentration value Nₓ is updated in this way, thereby managing the pigment concentration in the ink in the circulation path.

For the evaporation amount V acquired in step S4 of FIG. 8, the evaporation speed of the ink in the orifices OP is set, and the evaporation amount V is calculated from the set evaporation speed. FIG. 9A is the calculation procedure of the evaporation amount V acquired in step S4 of FIG. 8. FIG. 9B shows a table to be looked up to change the evaporation speed in accordance with the head temperature and the humidity.

In step S11, acquisition of the temperature of the temperature sensor SR is started. The detection result of the temperature sensor SR is sampled by the head control unit 25 at an interval of 100 msec for each of the heater boards HB0 to HB16.

In step S12, the humidity sensor 153 starts measuring the humidity. Next, in step S13, a printing time T is calculated. The printing time T is the time (sec) after the cap 10 is opened upon receiving a print instruction (time T0) until the discharge heads 11 are lowered from the retreat position to the printing position at the height h1, the printing operation is ended, and capping is completed again (time T1) (T=T1−T0). The printing time T can be calculated by measurement.

In step S14, the average value of the temperatures of each of the heater boards HB0 to HB16 during the printing time T is calculated, and the average value of the temperatures of the 17 heater boards HB0 to HB16 is further calculated. In step S15, the average value of the detection results (humidities) of the humidity sensor 153 during the printing time T is calculated. As the humidity, a weight absolute humidity (unit: kg/kgDryAir) is calculated.

In step S16, the table is looked up, and an evaporation speed Vr is set. At this time, the value of the evaporation speed is set in accordance with the average values of the temperatures and humidities calculated in steps S14 and S15. FIG. 9B shows an example of an evaporation speed setting table. The evaporation speed Vr is the speed per orifice OP and is defined by a unit [ng/s]. If the humidity is in a range H1, and the temperature is in a range T1, the evaporation speed Vr is 14 [ng/s].

The ranges are as follows.
Range H1: humidity<0.004
Range H2: 0.004≤humidity<0.007
Range H3: 0.007≤humidity<0.010
Range H4: 0.010≤humidity<0.013
Range H5: 0.013≤humidity
Range T1: temperature<35° C.
Range T2: 35° C.≤temperature<40° C.
Range T3: 40° C.≤temperature

In step S17, the evaporation amount V is calculated. The evaporation amount V is calculated by

$$V = Vr \times T \times N$$

Here, N is the number of orifices OP. For example, assuming that there exist 512×4 columns=2,048 orifices OP in each of the heater boards HB0 to HB16, the total number of orifices OP in one discharge head 11 is 34,816. The evaporation amount is thus estimated.

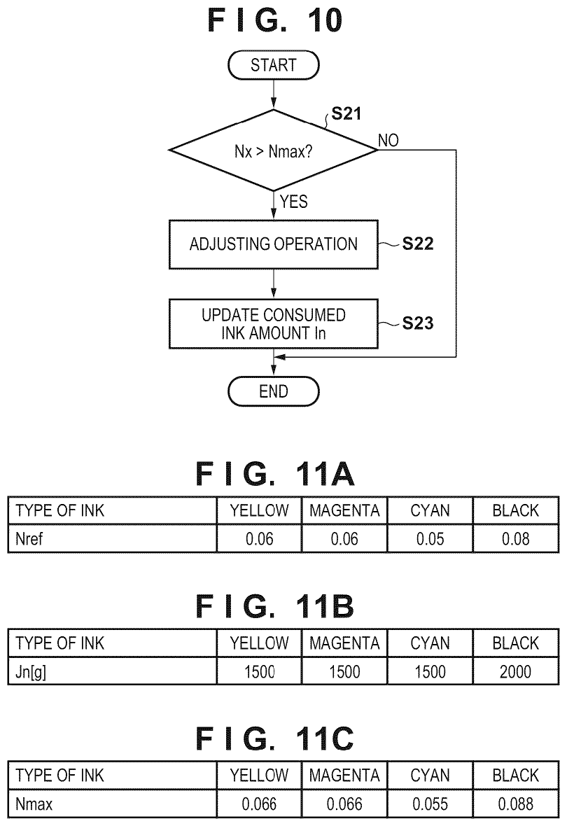

FIG. 10 is a flowchart showing an example of processing associated with execution of the adjusting operation and shoes concentration determination processing executed next to the processing shown in FIG. 8. In step S21, it is determined whether the estimated concentration value Ny exceeds a predetermined upper limit value Nₘₐₓ (predetermined concentration). FIG. 11C shows an example of the upper limit value Nₘₐₓ. The upper limit value Nₘₐₓ is set for each ink type and stored in, for example, the storage device of the concentration control unit 29.

Referring back to FIG. 10, if the estimated concentration value Nₓ does not exceed the upper limit value Nₘₐₓ, the processing is ended. If the estimated concentration value Nₓ exceeds the upper limit value Nₘₐₓ, the process advances to step S22. In step S22, the adjusting operation is executed. As described above, the adjusting operation includes the operation of removing ink from the discharge heads 11. At this time, the higher the estimated concentration value Ng is, the larger the ink removal amount may be. The removal amount may be increased by increasing the removal amount in one operation or increasing the number of times of removal. In step S23, the consumed ink amount Iₙ is increased by the removal amount of the ink removed in step S22. The processing is thus ended.

As described above, in this embodiment, the detection result of the humidity sensor 153, which has correlation with the actual humidity near the orifices OP is used, thereby improving the accuracy of estimating the concentration of the solid component in ink. As a result, it is possible to prevent the ink from being wastefully removed in the adjusting operation and reducing ink consumption.

### Second Embodiment

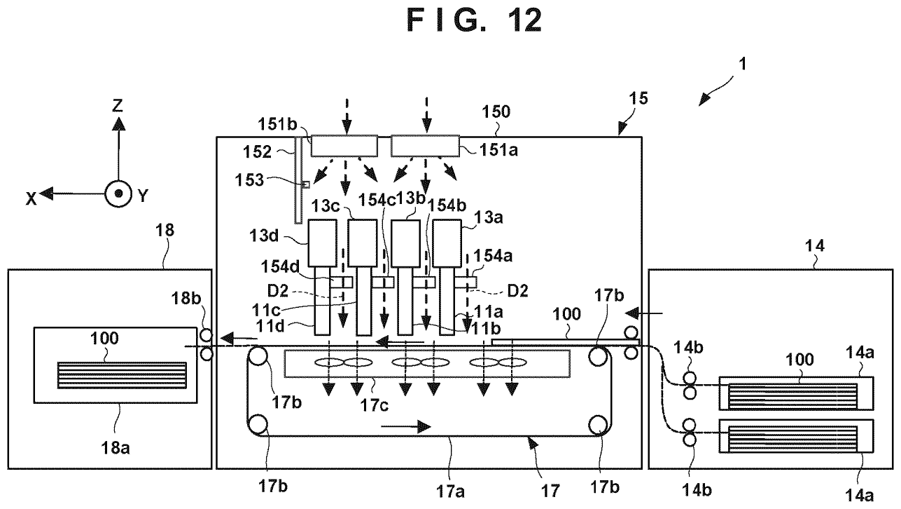

In this embodiment, a configuration example in which blowing units are arranged at a plurality of positions will be described. FIG. 12 is a schematic view of a printing apparatus 1 according to this embodiment. In the example shown in FIG. 12, blowing units 154a to 154d are installed on side portions (side surfaces in the X direction) of corresponding discharge heads 11a to 11d. The blowing units 154a to 154d are electric fans each of which generates an airflow downward in the Z direction. Arrows D2 indicate the paths and directions of airflows generated by the blowing units 154a to 154d. The airflow flows to the lower side between the adjacent discharge heads 11, and reaches orifice surfaces 110. The airflows indicated by the arrows D2 include air of blowing units 151a and 151b. When the air is blown to the orifices OP, the humidity of the air near the orifices OP can be stabilized.

A humidity sensor 153 is located on the downstream side of the blowing units 151a and 151b and on the upstream side of the blowing units 154a to 154d. The humidity of air sucked by the blowing units 154a to 154d is detected by the humidity sensor 153. With this arrangement, the humidity of air sent from the blowing units 151a and 151b is detected, and the air whose humidity is detected is more reliably sent to the vicinity of the orifices OP by the blowing units 154a to 154d.

The configuration according to this embodiment is advantageous in an apparatus that needs to make the X-direction interval between the adjacent discharge heads 11 narrow due to restrictions concerning the space or the like because air readily reaches the vicinity of the orifices OP. It is therefore possible to obtain an effect of improving the correlation between the detection result of the humidity sensor 153 and the actual humidity near the orifices OP.

### Third Embodiment

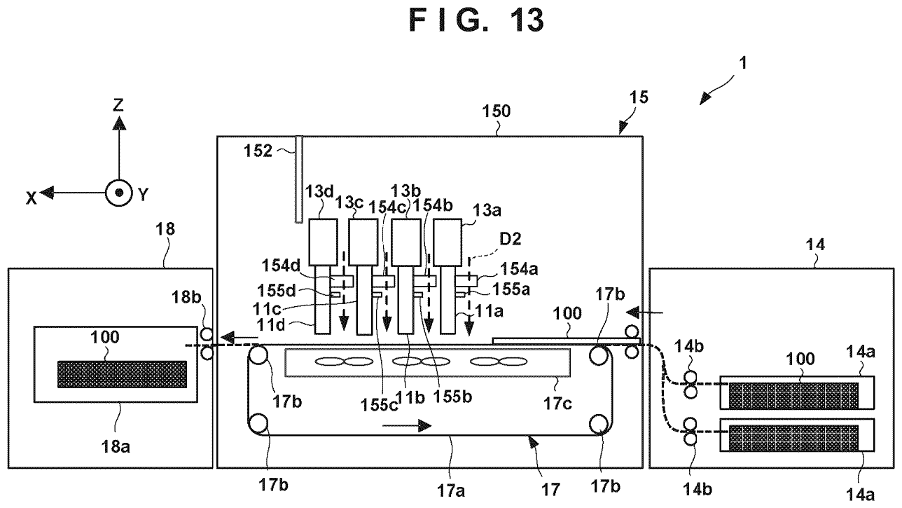

In this embodiment, humidity sensors are arranged between adjacent discharge heads 11. FIG. 13 is a schematic view of a printing apparatus 1 according to this embodiment, showing an example. In the example shown in FIG. 13, blowing units 154a to 154d are installed on side portions (side surfaces in the X direction) of corresponding discharge heads 11a to 11d. Each of the humidity sensors 155a to 155d is arranged at a position apart from an orifice surface 110 of the corresponding discharge head by a predetermined distance (for example, 100 mm).

In this embodiment, blowing units 154a to 154d are arranged on the side portions of the discharge heads 11a to 11d, as in the second embodiment. Each of the humidity sensors 155a to 155d is located on the downstream side of a corresponding one of the blowing units 154a to 154d. On the other hand, blowing units 151a and 151b are not provided.

Air is blown to the vicinity of orifices OP by the blowing units 154a to 154d, the humidity of the air can be detected by the humidity sensors 155a to 155d, and an effect of improving the correlation between the detection results of the humidity sensors 155a to 155d and the actual humidity near the orifices OP can be obtained.

Note that in this embodiment, an example in which the blowing units 151a and 151b are not provided has been described. However, a configuration in which these are provided may be employed.

### Fourth Embodiment

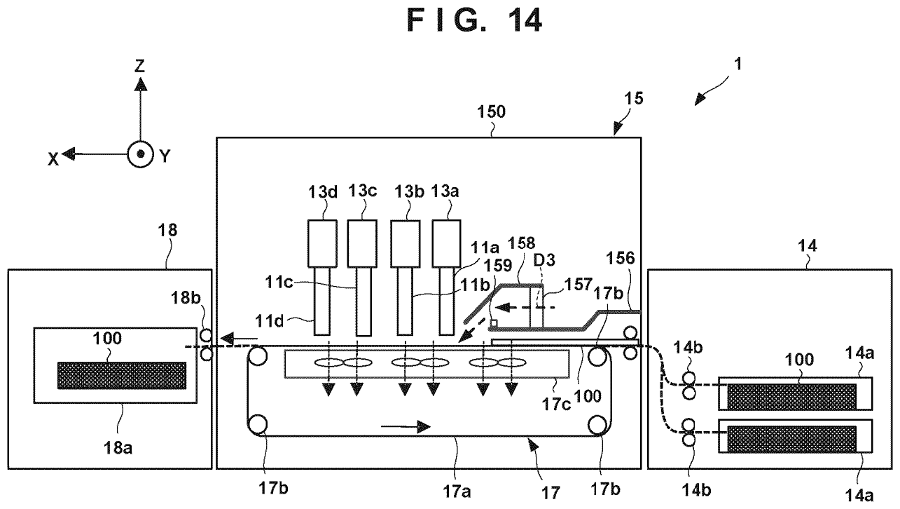

A blowing unit may be configured to blow air from a side of orifices OP. FIG. 14 is a schematic view of a printing apparatus 1 according to this embodiment. A blowing unit 157 is configured to blow air not from a position where outside air is taken but from a side (a side in the X direction) to the discharge heads 11. The blowing unit 157 is an electric fan supported by a support plate 156 fixed to a housing 150. The blowing unit 157 generates an airflow in a direction indicated by an arrow D3.

To concentratedly direct the airflow generated by the blowing unit 157 to the vicinity of the orifices OP, a guide plate 158 is provided around the blowing unit 157. The airflow generated by the blowing unit 157 flows to the vicinity of the orifices OP by the guide of the guide plate 158.

A humidity sensor 159 is installed on the support plate 156 on the downstream side of the blowing unit 157. The humidity sensor 159 can detect the humidity of air blown by the blowing unit 157. Since the air blown from the blowing unit 157 flows between an orifice surface 110 of the discharge head 11 and a conveyance belt 17a, an effect of improving the correlation between the detection result of the humidity sensor 159 and the humidity near the orifices OP can be obtained.

In this embodiment, the blowing unit 157 blows air from the upstream side to the downstream side (from right to left in the X direction in FIG. 14) in the conveyance direction of a print medium 100. Since an airflow generated by conveyance of the print medium 100 similarly flows from the upstream side to the downstream side in the conveyance direction, the direction of the airflow and the direction of blowing of the blowing unit 157 are made to match. When the direction of blowing matches the conveyance direction of the print medium 100, the air from the blowing unit 157, whose humidity is detected by the humidity sensor 159, can readily flow between the adjacent discharge heads 11.

### Fifth Embodiment

In the above-described embodiments, the detection result of the humidity sensor is used to estimate the concentration of ink. However, the detection result of the humidity sensor can also be used for another application purpose. For example, it can also be used for an application purpose of changing the discharge amount of ink in accordance with the detection result of the humidity sensor or an application purpose of changing the conveyance speed of a print medium 100.

### Sixth Embodiment

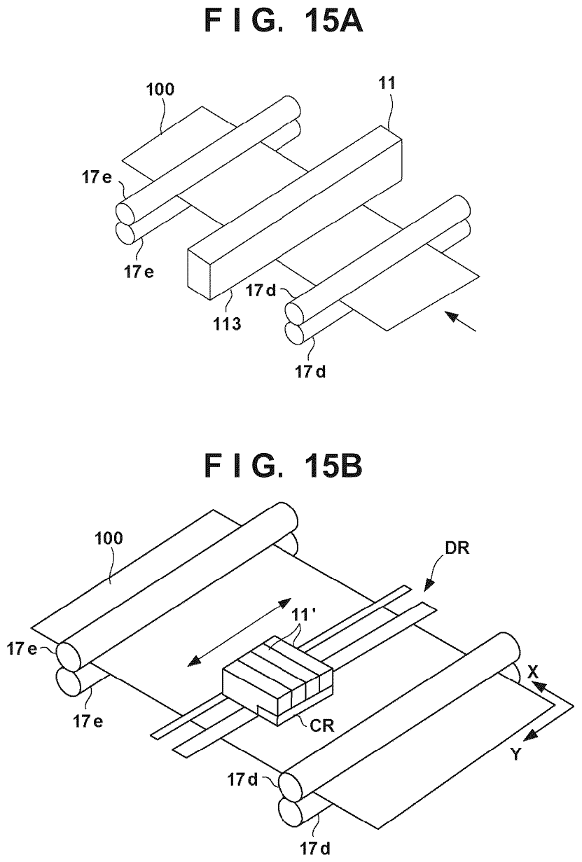

In the above-described embodiments, a conveyance belt type conveyance mechanism has been exemplified as the conveyance unit 17. However, a roller type conveyance mechanism may be used. FIG. 15A is a schematic view showing an example. Only one discharge head 11 is shown for the descriptive convenience. A roller pair 17d is arranged on the upstream side of the discharge head 11 in the conveyance direction of the print medium 100, and a roller pair 17e is arranged on the downstream side. The roller pair 17d conveys the print medium 100 by rotating while clamping the print medium 100. Similarly, the roller pair 17e conveys the print medium 100 by rotating while clamping the print medium 100.

### Seventh Embodiment

In the above-described embodiments, a full line type head has been exemplified as the discharge head 11. However, the present disclosure can also be applied to a serial type printing apparatus. FIG. 15B is a schematic view showing an example. A plurality of discharge heads 11′ are mounted on a carriage CR. The carriage CR is reciprocally moved by a scanning mechanism DR in a direction (Y direction) to traverse a print medium 100.

The scanning mechanism DR is, for example, a belt transmission mechanism, and includes a pair of pulleys apart in the Y direction, an endless belt wound around the pair of pulleys, and a motor that rotates the pulleys. The carriage CR is fixed to the endless belt, and the endless belt is made to travel by driving the motor, thereby moving the carriage CR. The carriage CR is an example of a moving mechanism that relatively moves the discharge heads 11′ and the print medium 100.

In the example shown in FIG. 15B, conveyance of the print medium 100 is performed by a roller type conveyance mechanism, as in the sixth embodiment. However, a conveyance belt type conveyance mechanism may be used, as in the first embodiment. Printing of an image is performed by alternately repeating a conveyance operation (intermittent conveyance operation) of conveying the print medium 100 in the X direction by a predetermined amount by roller pairs 17d and 17e and print scanning during stop of conveyance. The print scanning is an operation of discharging ink from the discharge heads 11′ while moving the carriage CR with the discharge heads 11′ mounted thereon.

### Eighth Embodiment

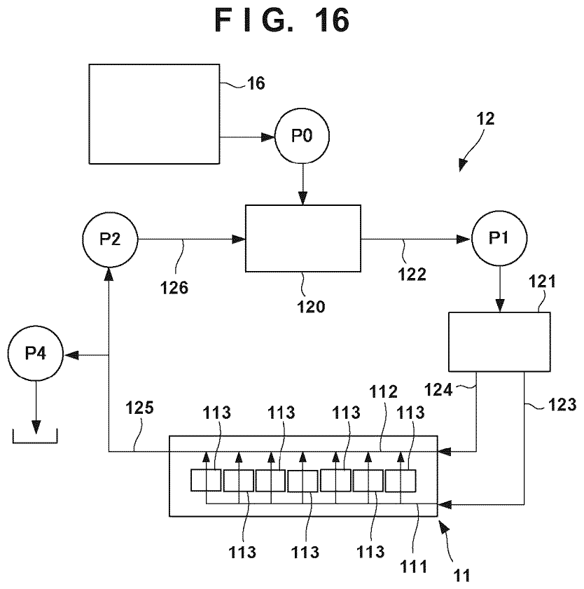

In the above-described embodiments, as the adjusting operation of adjusting the concentration of the solid component in ink circulated by the circulation unit 12, ink removal from the discharge heads 11 or 11′ has been exemplified. However, the ink may be removed from another part of the circulation path of the ink. FIG. 16 shows an example. FIG. 16 shows an example in which a pump P4 that removes ink from a pipe 125 between a discharge head 11 and a pump P2 to a waste liquid tank is provided. The concentrated ink can be removed by the pump P4 at a position on the downstream side of the discharge head 11 in the flowing direction of the circulation flow of the ink.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-134476, filed Aug. 9, 2024, which is hereby incorporated by reference herein in its entirety.

What is claimed is:

1. A printing apparatus comprising:
a moving unit configured to relatively move a print medium and a discharging unit including an orifice configured to discharge a liquid to the print medium;
a blowing unit configured to blow air to the orifice; and
a detection unit configured to detect a humidity of the air.

2. A printing apparatus comprising:
a moving unit configured to relatively move a print medium and a discharging unit including an orifice configured to discharge a liquid to the print medium;
a blowing unit configured to blow air to the orifice; and
a detection unit configured to detect a humidity,
wherein the detection unit is arranged on a path of an airflow generated by the blowing unit.

3. The apparatus according to claim 2, wherein
the detection unit is arranged on a downstream side of the blowing unit in a flowing direction of the airflow.

4. The apparatus according to claim 2, wherein
the detection unit is arranged on an upstream side of the blowing unit in a flowing direction of the airflow.

5. The apparatus according to claim 1, wherein
a flow velocity of the airflow blown by the blowing unit is higher than a relative moving speed between the print medium and the discharging unit.

6. The apparatus according to claim 1, further comprising a second discharging unit including an orifice configured to discharge a liquid to the print medium,
wherein the moving unit relatively moves the print medium, and the discharging unit and the second discharging unit in a predetermined direction,
the discharging unit and the second discharging unit are arranged side by side in the predetermined direction, and
the blowing unit is arranged such that the air passes between the discharging unit and the second discharging unit.

7. The apparatus according to claim 1, further comprising a control unit configured to control an adjusting operation of adjusting a concentration of a solid component of the liquid based on a detection result of the detection unit.

8. The apparatus according to claim 7, further comprising a circulation unit configured to circulate the liquid between the discharging unit and a liquid storage unit configured to store the liquid.

9. The apparatus according to claim 8, wherein the adjusting operation includes an operation of removing the liquid from the discharging unit.

10. The apparatus according to claim 8, wherein the adjusting operation includes an operation of discharging the liquid from the discharging unit.

11. The apparatus according to claim 8, wherein the adjusting operation includes an operation of sucking the liquid from the discharging unit.

12. The apparatus according to claim 1, wherein the discharging unit is a full line type discharge head.
